(19) United States
(12) Patent Application Publication
(10) Pub. No.: US 2017/0076629 A1
(43) Pub. Date: Mar. 16, 2017

(54) APPARATUS AND METHOD FOR SUPPORTING CHOREOGRAPHY

(71) Applicant: ELECTRONICS AND TELECOMMUNICATIONS RESEARCH INSTITUTE, Daejeon (KR)

(72) Inventors: Do-Hyung KIM, Daejeon (KR); Jae-Hong KIM, Daejeon (KR); Young-Woo YOON, Daejeon (KR); Min-Su JANG, Daejeon (KR); Cheon-Shu PARK, Daejeon (KR); Sung-Woong SHIN, Daejeon (KR)

(73) Assignee: ELECTRONICS AND TELECOMMUNICATIONS RESEARCH INSTITUTE, Daejeon (KR)

(21) Appl. No.: 15/059,946

(22) Filed: Mar. 3, 2016

(30) Foreign Application Priority Data
Sep. 14, 2015 (KR) 10-2015-0129618
Jan. 8, 2016 (KR) 10-2016-0002743

(51) Int. Cl. G09B 19/00; G06F 17/30; G06K 9/62; G09B 5/02; G06K 9/46

(52) U.S. Cl. CPC G09B 19/0015; G09B 5/02; G06K 9/4604; G06K 9/6215; G06F 17/30277

(57) ABSTRACT

Disclosed herein are an apparatus and method for supporting choreography, which can easily and systematically search for existing dances through various interfaces and can check the simulation of the found dances. For this, the apparatus includes a dance motion DB for storing pieces of motion capture data about respective multiple dance motions, a dance attribute DB for storing pieces of biomechanical information about respective multiple dance motions, a search unit for receiving a search target dance from a user using a method corresponding to at least one of a sectional motion search and a dance attribute search, and searching the dance motion DB and the dance attribute DB for choreographic data based on similarity determination, and a display unit for displaying choreographic data of the dance motion DB and the dance attribute DB, found as a result of the search based on similarity determined by the search unit.

### CROSS REFERENCE TO RELATED APPLICATIONS

This application claims the benefit of Korean Patent Application Nos. 10-2015-0129618, filed Sep. 14, 2015, and 10-2016-0002743, filed Jan. 8, 2016, which are hereby incorporated by reference in their entirety into this application.

### BACKGROUND OF THE INVENTION

1. Technical Field

The present invention relates generally to an apparatus and method for supporting choreography and, more particularly, to an apparatus and method for supporting choreography, which can easily and systematically search for existing dances through various interfaces and can check the simulation of the found dances.

2. Description of the Related Art

Korean pop music (K-pop) is the core content of the Korean wave, and the essential content leading the proliferation of the Korean wave. The force motivating the spread of K-pop all over the world is K-pop dance. As music has changed to become not just an auditory but also a visual art form, it is no exaggeration to say that the key to the popularity of K-pop is dance. Foreign media defines K-pop as dance music sung by Korean idol singers or groups. K-pop dance has greatly contributed to the improvement of the image of the Korean wave and the creation of national wealth in such a way that cover dances have become viral to thus cause the whole world, particularly South America, to follow K-pop dance.

In spite of the global popularity of K-pop dance, research into the acquisition of Information Technology (IT)-based technology and data related to K-pop dances has never been conducted. In order to continue the spread of the Korean wave, including K-pop dance, and to develop and grow the K-pop dance content industry, the development of scientific and systematic IT technology is urgently required.

The present invention relates to technology for supporting the choreography work of K-pop dance choreographers using IT technology so as to meet the requirement.

The choreographic process for creating K-pop dance motions, which is detected through an interview with K-pop dance choreographers, is described below. First, a dance motion (or dance step) suitable for the designated K-pop dance music is designed. For the design, each choreographer remembers his or her known dance motions, or randomly searches for similar dance videos on YouTube or the like so as to obtain ideas, or exchanges opinions with fellow choreographers. The initial choreography stage requires repeated trial and error, and incurs a lot of expense in the procedure for sketching the overall choreography. When the initial sketch of choreography is completed, detailed actions (motions) are determined in subsequent stages, and thus the final choreography is completed.

Currently, no apparatus and method for supporting choreography so as to support the creation of K-pop dance has been devised.

Meanwhile, there are multiple motion capture search systems for searching for various types of motion capture data such as actions, sports, and dancing, but all such systems adopt a method for setting a part of the motion capture data as a search target action and searching a database (DB) for motion capture data that exhibits a posture and motion similar to those of the search target action. Therefore, there is a great difference from the present invention, which is composed of search/input/output User Interfaces (UIs) specialized for the creation of dances.

The term “motion capture” denotes an animation creation technique for attaching markers or sensors to a person and acquiring information about the motion of marker positions, occurring according to the movement of the person, using a computer so as to express the natural motion of a figure.

In relation to this technology, Korean Patent Application Publication No. 2011-0083329 discloses “Choreography Production System and Choreography Production Method”.

### SUMMARY OF THE INVENTION

Accordingly, the present invention has been made keeping in mind the above problems occurring in the prior art, and an object of the present invention is to support the dance creation work of choreographers. In detail, the object of the present invention is to easily search for dances having a motion and an attribute that are sought by a choreographer.

Another object of the present invention is to support an initial choreography stage when dances are created. In detail, the present invention is intended to allow a choreographer to easily, promptly, and systematically search for similar dances, which were conventionally created, through various interfaces, and to promptly check an initial sketch of choreography through editing and simulation of the found dances.

A further object of the present invention is not only to search for dances using a motion as a query, but also to search for similar dances using the attributes of dances, when searching for dances. Yet another object of the present invention is to accurately simulate the motions of dances, found as the result of the search, via an omnidirectional three-dimensional (3D) viewer.

In accordance with an aspect of the present invention to accomplish the above objects, there is provided an apparatus for supporting choreography, including a dance motion database (DB) for storing pieces of motion capture data about respective multiple dance motions; a dance attribute DB for storing pieces of biomechanical information about respective multiple dance motions; a search unit for receiving a search target dance from a user using a method corresponding to at least one of a sectional motion search and a dance attribute search, and searching the dance motion DB and the dance attribute DB for choreographic data based on a similarity determination; and a display unit for displaying choreographic data of the dance motion DB and the dance attribute DB, found as a result of the search based on a similarity determined by the search unit, to the user.

The sectional motion search may be a search based on at least one of a video file and a camera-captured image, which are input by the user, and the dance attribute search may be a search based on at least one of a query and an audio file related to attributes of dances.

The search unit may include a similar motion search module for performing a search of the dance motion DB based on the similarity determination when the search target dance is received from the user using the sectional motion search; and a dance attribute search module for performing a search of the dance attribute DB based on the similarity determination when the search target dance is received from the user using the dance attribute search.

The similar motion search module may include a skeletal information extraction unit for extracting a skeletal information sequence including pieces of position information of respective joints via extraction of a skeletal structure of a body from the search target dance contained in the video file input by the user and in the camera-captured image; a feature description unit for extracting a feature descriptor for specifying a posture of the search target dance based on the skeletal information sequence; a feature matching unit for comparing and matching the feature descriptor with the motion capture data stored in the dance motion DB, and then outputting a matching distance matrix; and a dynamic matching search unit for calculating a similarity between the search target dance and the motion capture data based on the matching distance matrix.

The search unit may be configured to, when the search target dance is received using both the sectional motion search and the dance attribute search, assign weights to the sectional motion search and the dance attribute search upon performing the similarity determination.

The biomechanical information may be at least one of kinematic information, kinetic information, and energy consumption information.

The kinematic information may be information about a position and motion of a body and includes information about angles of respective joints; the kinetic information may be information about a force influencing the motion of the body and includes ground reaction and moment information; and the energy consumption information may be data estimated based on both a heart rate, which is measured using a heart rate monitor, and a muscle activity amount, which is a biometric signal extracted by a myoelectric sensor, and includes global energy consumption and local energy consumption information about each body part.

The search unit may be configured such that the dance attribute search is performed based on a query from the user, related to at least one of a tempo, power, flexibility, complexity, space utilization, difficulty, and focused body part of each dance motion.

The display unit may provide a function for omnidirectionally viewing the choreographic data to the user.

The display unit may display the biomechanical information in the choreographic data in different colors for respective levels.

In accordance with another aspect of the present invention to accomplish the above objects, there is provided a method for supporting choreography, including storing pieces of motion capture data about respective multiple dance motions in a dance motion database (DB); storing pieces of biomechanical information about respective multiple dance motions in a dance attribute DB; receiving a search target dance from a user using a method corresponding to at least one of a sectional motion search and a dance attribute search; searching the dance motion DB and the dance attribute DB for choreographic data based on a similarity determination; and displaying choreographic data of the dance motion DB and the dance attribute DB, found as a result of the search based on a similarity determined in the searching, to the user.

The sectional motion search may be a search based on at least one of a video file and a camera-captured image, which are input by the user, and the dance attribute search may be a search based on at least one of a query and an audio file related to attributes of dances.

Searching the dance motion DB and the dance attribute DB may include performing a search of the dance motion DB based on the similarity determination when the search target dance is received from the user using the sectional motion search; and performing a search of the dance attribute DB based on the similarity determination when the search target dance is received from the user using the dance attribute search.

Performing the search of the dance motion DB may include extracting a skeletal information sequence including pieces of position information of respective joints via extraction of a skeletal structure of a body from the search target dance contained in the video file input by the user and in the camera-captured image; extracting a feature descriptor for specifying a posture of the search target dance based on the skeletal information sequence; comparing and matching the feature descriptor with the motion capture data stored in the dance motion DB, and then outputting a matching distance matrix; and calculating a similarity between the search target dance and the motion capture data based on the matching distance matrix.

Receiving the search target dance may be configured to, when the search target dance is received using both the sectional motion search and the dance attribute search, assign weights to the sectional motion search and the dance attribute search upon performing the similarity determination.

The biomechanical information may be at least one of kinematic information, kinetic information, and energy consumption information.

The kinematic information may be information about a position and motion of a body and includes information about angles of respective joints; the kinetic information may be information about a force influencing the motion of the body and includes ground reaction and moment information; and the energy consumption information may be data estimated based on both a heart rate, which is measured using a heart rate monitor, and a muscle activity amount, which is a biometric signal extracted by a myoelectric sensor, and includes global energy consumption and local energy consumption information about each body part.

Receiving the search target dance may be configured such that the dance attribute search is performed based on a query from the user, related to at least one of a tempo, power, flexibility, complexity, space utilization, difficulty, and focused body part of each dance motion.

Displaying the choreographic data may be configured to provide a function for omnidirectionally viewing the choreographic data to the user.

Displaying the choreographic data may be configured to display the biomechanical information in the choreographic data in different colors for respective levels.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a block diagram showing the configuration of an apparatus for supporting choreography according to an embodiment of the present invention;

FIG. 2 is a diagram illustrating the items of biomechanical information stored in a dance attribute DB in the apparatus for supporting choreography according to an embodiment of the present invention;

FIG. 3 is a block diagram showing the configuration of a similar motion search module in the apparatus for supporting choreography according to the present invention;

FIG. 4 is a diagram showing an example of the display on a display unit in the apparatus for supporting choreography according to an embodiment of the present invention;

FIG. 5 is a diagram showing another example of the display on the display unit in the apparatus for supporting choreography according to an embodiment of the present invention;

FIG. 6 is a flowchart showing a method for supporting choreography according to an embodiment of the present invention;

FIG. 7 is a flowchart showing in greater detail a search step in the method for supporting choreography according to an embodiment of the present invention;

FIG. 8 is a flowchart showing in greater detail the step of performing a search of a dance motion DB in the method for supporting choreography according to an embodiment of the present invention; and

FIG. 9 illustrates a computer that implements an apparatus for supporting choreography according to an example.

### DESCRIPTION OF THE PREFERRED EMBODIMENTS

The present invention will be described in detail below with reference to the accompanying drawings. Repeated descriptions and descriptions of known functions and configurations which have been deemed to make the gist of the present invention unnecessarily obscure will be omitted below. The embodiments of the present invention are intended to fully describe the present invention to a person having ordinary knowledge in the art to which the present invention pertains. Accordingly, the shapes, sizes, etc. of components in the drawings may be exaggerated to make the description clearer.

Hereinafter, the configuration and operation of an apparatus for supporting choreography according to an embodiment of the present invention will be described.

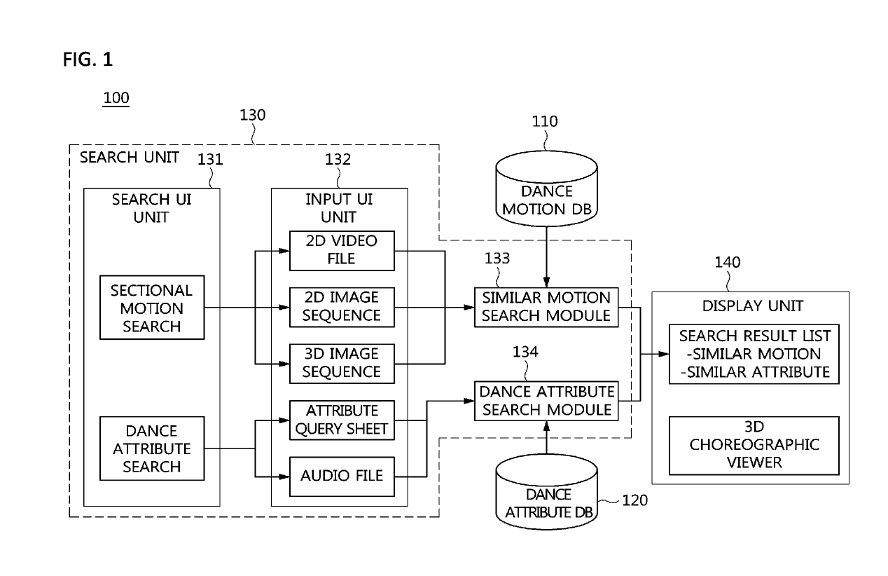

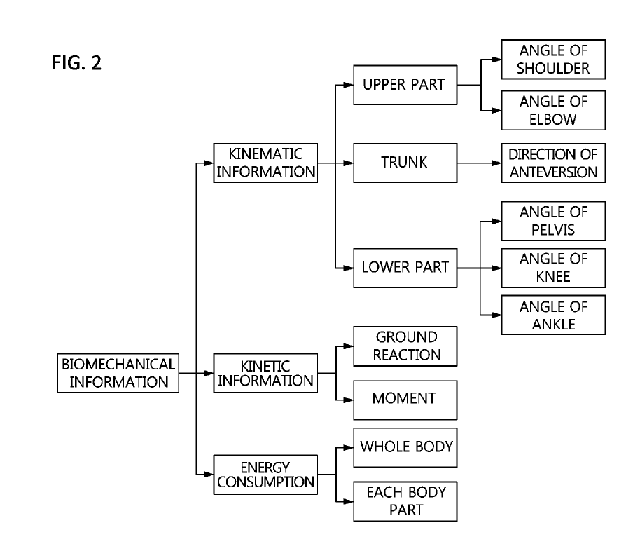

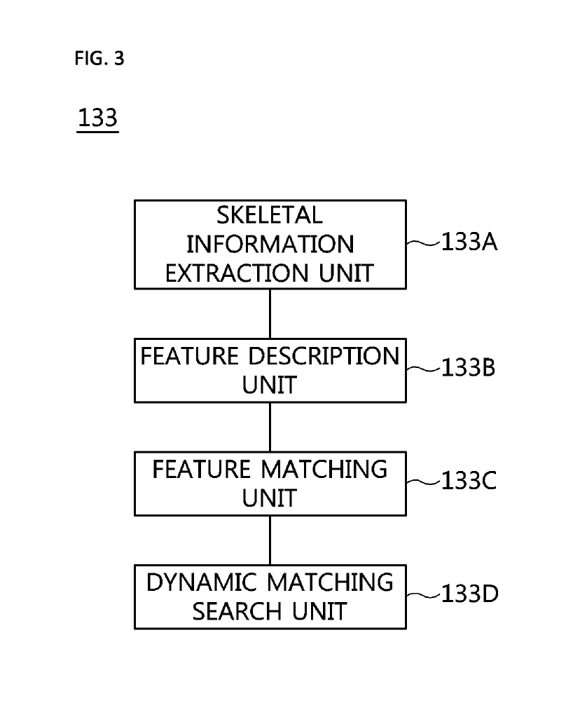

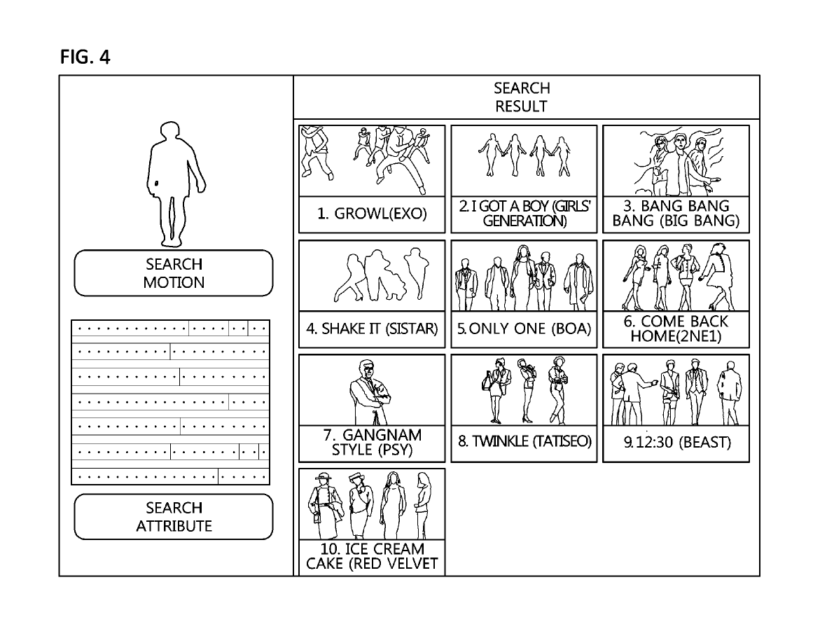

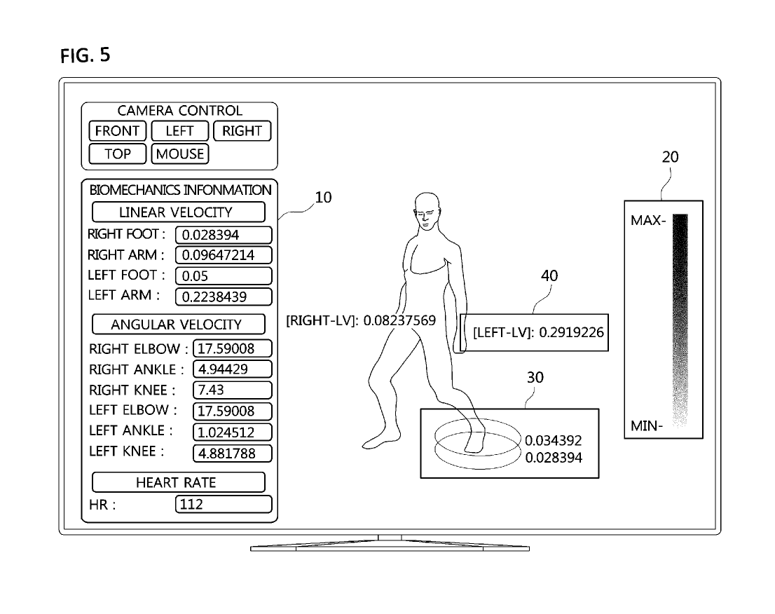

FIG. 1 is a block diagram showing the configuration of an apparatus for supporting choreography according to an embodiment of the present invention. FIG. 2 is a diagram illustrating the items of biomechanical information stored in a dance attribute DB in the apparatus for supporting choreography according to an embodiment of the present invention. FIG. 3 is a block diagram showing the configuration of a similar motion search module in the apparatus for supporting choreography according to the present invention. FIG. 4 is a diagram showing an example of the display on a display unit in the apparatus for supporting choreography according to an embodiment of the present invention. FIG. 5 is a diagram showing another example of the display on the display unit in the apparatus for supporting choreography according to an embodiment of the present invention.

Referring to FIG. 1, an apparatus 100 for supporting choreography according to an embodiment of the present invention includes a dance motion DB 110, a dance attribute DB 120, a search unit 130, and a display unit 140.

The dance motion DB 110 stores pieces of motion capture data about respective multiple dance motions.

The dance attribute DB 120 stores pieces of biomechanical information about respective multiple dance motions. In this case, the biomechanical information may be at least one of kinematic information, kinetic information, and energy consumption information. The kinematic information is information about the position and motion of a body, and may be composed of pieces of information about the angles of respective joints. The kinetic information is information about a force influencing the motion of the body, and may include ground reaction and moment information. The energy consumption information is data estimated based on both a heart rate, which is measured using a heart rate monitor, and a muscle activity amount, which is a biometric signal extracted by a myoelectric sensor, and may include global energy consumption information and local energy consumption information about each body part. FIG. 2 illustrates an example of a tree of biomechanical information items.

The search unit 130 receives a search target dance from a user using a method corresponding to at least one of a sectional motion search and a dance attribute search, and searches the dance motion DB 110 and the dance attribute DB 120 for choreographic data based on a similarity determination. In detail, the search unit 130 may include a search UI unit 131, an input UI unit 132, a similar motion search module 133, and a dance attribute search module 134.

The search UI unit 131 may determine which one of the sectional motion search and the dance attribute search has been selected, based on a search means input by the user. One of the sectional motion search and the dance attribute search may be selected and used to perform a subsequent procedure, or both the sectional motion search and the dance attribute search may be selected and used to perform a subsequent procedure. Here, when the search target dance is received using both the sectional motion search and the dance attribute search, configuration may be implemented such that respective weights are assigned to the sectional motion search and the dance attribute search when performing a similarity determination. For example, when a choreographer assigns a higher weight to the motion search, motion similarity takes a large part of the overall similarity in similarity lists presented by the similar motion search module 133 and the dance attribute search module 134, which will be described later, and thus dances having similar motions are ranked more highly in search result lists. If weights are equally assigned, motion similarity and attribute similarity take the same part of the overall similarity.

The input UI unit 132 may receive at least one of a video file (e.g. 2D video file) and a camera-captured image (e.g. 2D image sequence, 3D image sequence, etc.), which are input by the user as a means of the sectional motion search. That is, the choreographer may search the dance motion DB 110 for motions similar to a query motion presented by the choreographer via the sectional motion search. For example, the 2D video file is a method for inputting another person's dance video file, acquired from YouTube or the like, and searching for motions similar to that of the dance video file. The 2D/3D image sequence is an intuitive input method for allowing the choreographer to personally do a dance designed by him or her in front of a 2D/3D camera and input the corresponding dancing image.

Further, the input UI unit 132 may receive at least one of a query and an audio file related to the attributes of dances as a means of the dance attribute search. Here, the query may be at least one of the tempo, power, flexibility, complexity, space utilization, difficulty, and focused body part of each dance motion.

When the search target dance is received from the user using the sectional motion search, the similar motion search module 133 may search the dance motion DB 110 for motions based on a similarity determination.

Referring to FIG. 3 together with the preceding drawings, the similar motion search module 133 may include a skeletal information extraction unit 133A, a feature description unit 133B, a feature matching unit 133C, and a dynamic matching search unit 133D.

The skeletal information extraction unit 133A extracts a skeletal information sequence composed of pieces of position information of respective joints via the extraction of the skeletal structure of a body from the search target dance contained in the video file and the camera-captured image, which are input by the user. The feature description unit 133B extracts a feature descriptor for specifying the posture of the search target dance based on the skeletal information sequence. The feature matching unit 133C compares and matches the feature descriptor with the motion capture data stored in the dance motion DB 110, and then outputs a matching distance matrix. The dynamic matching search unit 133D calculates a similarity between the search target dance and the motion capture data based on the matching distance matrix.

When the search target dance is received from the user using the dance attribute search, the dance attribute search module 134 searches the dance attribute DB 120 for attributes based on a similarity determination.

The dance attribute search module is a module for searching the dance attribute DB for attributes similar to those of an input attribute query sheet and an input audio file, and outputting a list of similar attribute dances, sorted in the sequence of attribute similarity. The method for extracting information contained in the above-described attribute query sheet is described below.

1) Tempo of dance motion

calculate the linear velocity of each joint in biomechanical kinematic information

2) Power of dance motion

calculate ground reaction and the amount of moment in the biomechanical kinetic information

3) Flexibility of dance motion

calculate the trajectory shape and angular velocity/angular acceleration of each joint in the biomechanical kinematic information

4) Complexity of dance motion

calculate the trajectory complexity and motion repeatability of each joint in the biomechanical kinematic information

5) Space utilization of dance motion

calculate the volume of space based on the trajectory of each joint in the biomechanical kinematic information

6) Difficulty of dance motion

calculate the relative position and biomechanical energy consumption of each joint based on a body model

7) Focused body part (active body part) of dance motion (upper part, trunk, lower part, or whole body)

calculate the velocity/trajectory of each joint in the biomechanical kinematic information in the form of the relative ratio of respective body parts

The display unit 140 displays the choreographic data of the dance motion DB 110 and of the dance attribute DB 120, which is found as the result of the search based on the similarity determined by the search unit, to the user. The display unit 140 may provide a function of omnidirectionally viewing the choreographic data (through an omnidirectional 3D viewer) to the user. Further, the display unit 140 may display biomechanical information in the choreographic data in different colors for respective levels. Referring to FIG. 4 together with the preceding drawings, an input sectional motion search and an input dance attribute search may be displayed on one side of the screen of the display unit 140, and a list of dances corresponding to the result of the search may be displayed in the sequence of similarity on the other side of the screen. Referring to FIG. 5 together with the preceding drawings, an example in which a specific dance is expressed on the display unit 140 is illustrated. On one side of the screen, a biomechanical information window 10 may be displayed. The biomechanical information window 10 is a window in which biomechanical information configured in the form of a table is converted and displayed, and in which the angular velocity and linear velocity of each body part and the heart rate may be indicated. Further, the screen may be configured to include a biomechanical information level-based color guide 20, a first part display field 30, and a second part display field 40. Although the biomechanical information level-based color guide 20 is displayed in the shades of grayscale in FIG. 5, it is a guide bar in which pieces of biomechanical information for respective parts may be represented in different colors for respective levels. For example, the guide bar may be configured such that, as the color is closer to red, a higher numerical value is represented, and as the color is closer to green, a lower numerical value is represented. As an example of the first part display field 30, an arm is represented in FIG. 5. Along the motion of the arm, a trailing effect may be assigned using the biomechanical information in the corresponding frame, given data may be represented in respective colors, and actual biomechanical information may be indicated together as numerical values. As an example of the second part display field 40, a foot is represented in FIG. 5. Along the motion of the foot, a circular particle effect may be assigned using the biomechanical information of a corresponding frame, given data may be represented in colors, and actual biomechanical information may be indicated together as numerical values.

Hereinafter, a method for supporting choreography according to an embodiment of the present invention will be described in detail.

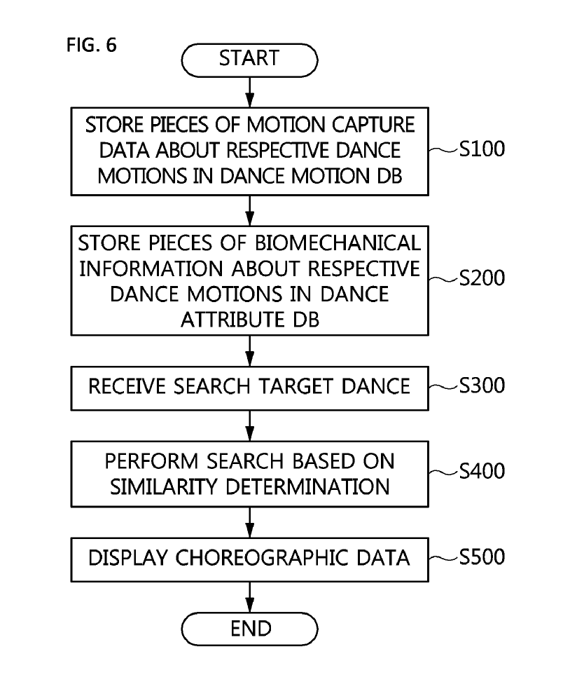

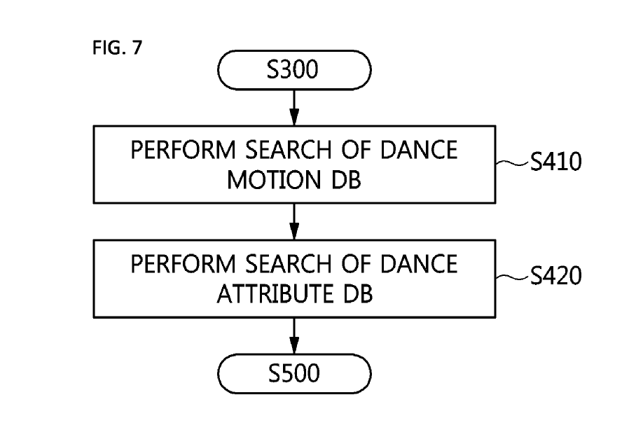

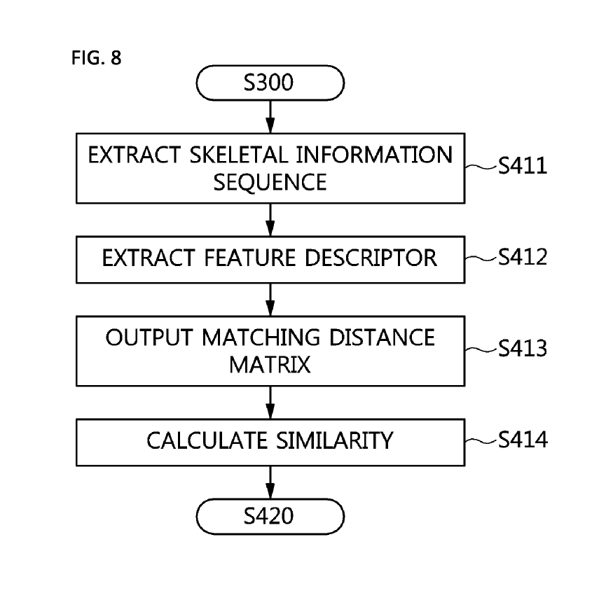

FIG. 6 is a flowchart showing a method for supporting choreography according to an embodiment of the present invention. FIG. 7 is a flowchart showing in greater detail a search step in the method for supporting choreography according to an embodiment of the present invention. FIG. 8 is a flowchart showing in greater detail the step of performing a search of a dance motion DB in the method for supporting choreography according to an embodiment of the present invention.

Referring to FIG. 6, the method for supporting choreography according to the embodiment of the present invention stores pieces of motion capture data about respective multiple dance motions in a dance motion DB at step S100.

Pieces of biomechanical information about respective multiple dance motions are stored in a dance attribute DB at step S200. In this case, the biomechanical information may be at least one of kinematic information, kinetic information, and energy consumption information. The kinematic information is information about the position and motion of a body, and may be composed of pieces of information about the angles of respective joints. The kinetic information is information about a force influencing the motion of the body, and may include ground reaction and moment information. The energy consumption information is data estimated based on both a heart rate, which is measured using a heart rate monitor, and a muscle activity amount, which is a biometric signal extracted by a myoelectric sensor, and may include global energy consumption information and local energy consumption information about each body part.

Further, a search target dance is received from the user using a method corresponding to at least one of a sectional motion search and a dance attribute search at step S300. Here, the sectional motion search may be a search based on at least one of a video file and a camera-captured image, which are input by the user, and the dance attribute search may be a search based on at least one of a query and an audio file related to the attributes of dances. Further, the dance attribute search may be implemented using a query from the user, related to at least one of the tempo, power, flexibility, complexity, space utilization, difficulty and focused body part of each dance motion. Furthermore, when the search target dance is received using both the sectional motion search and the dance attribute search, configuration may be implemented such that, when the similarity determination is performed, respective weights are assigned to the sectional motion search and to the dance attribute search.

Thereafter, the search may be performed based on the similarity determination using the dance motion DB and the dance attribute DB at step S400. Step S400 may include the similar motion search step S410 of, when the search target dance is received from the user using the sectional motion search at step S300, performing a search of the dance motion DB based on a similarity determination, and the dance attribute search step S420 of, when the search target dance is received from the user using the dance attribute search at step S300, performing a search of the dance attribute DB based on the similarity determination.

Here, step S410 may include the step S411 of extracting a skeletal information sequence composed of pieces of position information of respective joints via the extraction of the skeletal structure of a body from the search target dance contained in the video file and the camera-captured image, which are input by the user, the step S412 of extracting a feature descriptor for specifying the posture of the search target dance based on the skeletal information sequence, the step S413 of comparing and matching the feature descriptor with the motion capture data stored in the dance motion DB and then outputting a matching distance matrix, and the step S414 of calculating a similarity between the search target dance and the motion capture data based on the matching distance matrix.

After step S400, the choreographic data of the dance motion DB and the dance attribute DB, found as the result of the search based on the similarity determined at step S400, may be displayed to the user at step S500. At step S500, a function for omnidirectionally viewing the choreographic data may be provided to the user. Further, at step S500, the biomechanical information in the choreographic data may be displayed in different colors for respective levels.

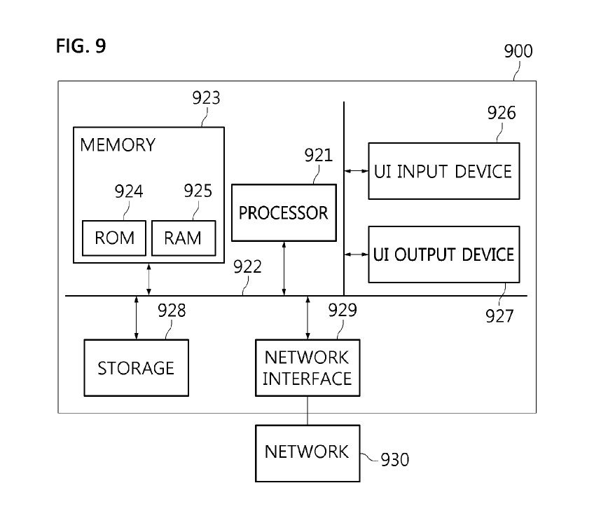

FIG. 9 illustrates a computer that implements an apparatus for supporting choreography according to an example.

The apparatus for supporting choreography may be implemented as a computer 900 illustrated in FIG. 9.

The apparatus for supporting choreography may be implemented in a computer system including a computer-readable storage medium. As illustrated in FIG. 9, the computer 900 may include at least one processor 921, memory 923, a user interface (UI) input device 926, a UI output device 927, and storage 928 that can communicate with each other via a bus 922. Furthermore, the computer 900 may further include a network interface 929 that is connected to a network 930. The processor 921 may be a semiconductor device that executes processing instructions stored in a central processing unit (CPU), the memory 923 or the storage 928. The memory 923 and the storage 928 may be various types of volatile or nonvolatile storage media. For example, the memory may include ROM (read-only memory) 924 or random access memory (RAM) 925.

At least one module of the apparatus for supporting choreography may be configured to be stored in the memory 923 and to be executed by at least one processor 921. Functionality related to the data or information communication of the apparatus for supporting choreography may be performed via the network interface 929.

The processor 921 may perform the above-described operations, and the storage 928 may store the above-described constants, variables and data, etc.

The method for supporting choreography according to the present invention may be implemented as program instructions that can be executed by various computer means. In this case, the program instructions may be recorded on a computer-readable storage medium. The computer-readable storage medium may include program instructions, data files, and data structures solely or in combination. The program instructions recorded on the storage medium may have been specially designed and configured for the present invention, or may be known to or available to those who have ordinary knowledge in the field of computer software. Examples of the computer-readable storage medium include all types of hardware devices specially configured to record and execute program instructions, for example, magnetic media, such as a hard disk, a floppy disk, and magnetic tape, optical media, such as compact disk (CD)-read only memory (ROM) and a digital versatile disk (DVD), magneto-optical media, such as a floptical disk, ROM, random access memory (RAM), and flash memory. Examples of the program instructions include machine language code, such as code created by a compiler, and high-level language code executable by a computer using an interpreter. The hardware devices may be configured to operate as one or more software modules in order to perform the operation of the present invention, and vice versa.

The teaching of the principles of the present invention may be implemented as a combination of hardware and software. Further, software may be implemented as an application program actually implemented in a program storage unit. The application program may be uploaded to a machine including any suitable architecture and may be executed by the machine. Preferably, the machine may be implemented on a computer platform having hardware components, such as one or more Central Processing Units (CPUs), a computer processor, RAM, and Input/Output (I/O) interfaces. Further, the computer platform may include an operating system and micro-instruction code. Various processes and functions described here may be a part of the micro-instruction code, a part of the application program, or any combination thereof, and may be executed by various processing devices including a CPU. In addition, various other peripheral devices such as an additional data storage unit and a printer may be connected to the computer platform.

Since some of the system components and methods illustrated in the attached drawings are preferably implemented using software, it should be additionally understood that actual connections between the system components or process function blocks may vary according to the scheme for programming the principles of the present invention. Here, when the teachings are given, those skilled in the art may take into consideration the principles of the present invention and similar embodiments or configurations thereof.

In accordance with the present invention, the dance creation work of choreographers may be supported. In detail, the present invention may easily search for dances having a motion and an attribute that are sought by a choreographer.

Further, the present invention may support an initial choreography stage when dances are created. In detail, the present invention allows a choreographer to easily, promptly, and systematically search for similar dances, which were conventionally created, through various interfaces, and to promptly check an initial sketch of choreography through editing and simulation of the found dances.

Furthermore, the present invention may not only search for dances using a motion as a query, but also search for similar dances using the attributes of dances, when searching for dances. In addition, the present invention may accurately simulate the motions of dances, found as the result of the search, via an omnidirectional 3D viewer.

As described above, in the apparatus and method for supporting choreography according to the present invention, the configurations and schemes in the above-described embodiments are not limitedly applied, and some or all of the above embodiments can be selectively combined and configured so that various modifications are possible.

What is claimed is:

1. An apparatus for supporting choreography, comprising:
a dance motion database (DB) for storing pieces of motion capture data about respective multiple dance motions;
a dance attribute DB for storing pieces of biomechanical information about respective multiple dance motions;
a search unit for receiving a search target dance from a user using a method corresponding to at least one of a sectional motion search and a dance attribute search, and searching the dance motion DB and the dance attribute DB for choreographic data based on a similarity determination; and
a display unit for displaying choreographic data of the dance motion DB and the dance attribute DB, found as a result of the search based on a similarity determined by the search unit, to the user.

2. The apparatus of claim 1, wherein the sectional motion search is a search based on at least one of a video file and a camera-captured image, which are input by the user, and the dance attribute search is a search based on at least one of a query and an audio file related to attributes of dances.

3. The apparatus of claim 2, wherein the search unit comprises:
a similar motion search module for performing a search of the dance motion DB based on the similarity determination when the search target dance is received from the user using the sectional motion search; and
a dance attribute search module for performing a search of the dance attribute DB based on the similarity determination when the search target dance is received from the user using the dance attribute search.

4. The apparatus of claim 3, wherein the similar motion search module comprises:
a skeletal information extraction unit for extracting a skeletal information sequence including pieces of position information of respective joints via extraction of a skeletal structure of a body from the search target dance contained in the video file which is input by the user and in the camera-captured image;
a feature description unit for extracting a feature descriptor for specifying a posture of the search target dance based on the skeletal information sequence;
a feature matching unit for comparing and matching the feature descriptor with the motion capture data stored in the dance motion DB, and then outputting a matching distance matrix; and
a dynamic matching search unit for calculating a similarity between the search target dance and the motion capture data based on the matching distance matrix.

5. The apparatus of claim 1, wherein the search unit is configured to, when the search target dance is received using both the sectional motion search and the dance attribute search, assign weights to the sectional motion search and the dance attribute search upon performing the similarity determination.

6. The apparatus of claim 1, wherein the biomechanical information is at least one of kinematic information, kinetic information, and energy consumption information.

7. The apparatus of claim 6, wherein the kinematic information is information about a position and motion of a body and includes information about angles of respective joints; the kinetic information is information about a force influencing the motion of the body and includes ground reaction and moment information; and the energy consumption information is data estimated based on both a heart rate, which is measured using a heart rate monitor, and a muscle activity amount, which is a biometric signal extracted by a myoelectric sensor, and includes global energy consumption and local energy consumption information about each body part.

8. The apparatus of claim 1, wherein the search unit is configured such that the dance attribute search is performed based on a query from the user, related to at least one of a tempo, power, flexibility, complexity, space utilization, difficulty, and focused body part of each dance motion.

9. The apparatus of claim 1, wherein the display unit provides a function for omnidirectionally viewing the choreographic data to the user.

10. The apparatus of claim 1, wherein the display unit displays the biomechanical information in the choreographic data in different colors for respective levels.

11. A method for supporting choreography, comprising:
storing pieces of motion capture data about respective multiple dance motions in a dance motion database (DB);
storing pieces of biomechanical information about respective multiple dance motions in a dance attribute DB;
receiving a search target dance from a user using a method corresponding to at least one of a sectional motion search and a dance attribute search;
searching the dance motion DB and the dance attribute DB for choreographic data based on a similarity determination; and
displaying choreographic data of the dance motion DB and the dance attribute DB, found as a result of the search based on a similarity determined in the searching, to the user.

12. The method of claim 11, wherein the sectional motion search is a search based on at least one of a video file and a camera-captured image, which are input by the user, and the dance attribute search is a search based on at least one of a query and an audio file related to attributes of dances.

13. The method of claim 12, wherein searching the dance motion DB and the dance attribute DB comprises:
performing a search of the dance motion DB based on the similarity determination when the search target dance is received from the user using the sectional motion search; and
performing a search of the dance attribute DB based on the similarity determination when the search target dance is received from the user using the dance attribute search.

14. The method of claim 13, wherein performing the search of the dance motion DB comprises:
extracting a skeletal information sequence including pieces of position information of respective joints via extraction of a skeletal structure of a body from the search target dance contained in the video file which is input by the user and in the camera-captured image;
extracting a feature descriptor for specifying a posture of the search target dance based on the skeletal information sequence;
comparing and matching the feature descriptor with the motion capture data stored in the dance motion DB, and then outputting a matching distance matrix; and
calculating a similarity between the search target dance and the motion capture data based on the matching distance matrix.

15. The method of claim 11, wherein receiving the search target dance is configured to, when the search target dance is received using both the sectional motion search and the dance attribute search, assign weights to the sectional motion search and the dance attribute search upon performing the similarity determination.

16. The method of claim 11, wherein the biomechanical information is at least one of kinematic information, kinetic information, and energy consumption information.

17. The method of claim 16, wherein the kinematic information is information about a position and motion of a body, and includes information about angles of respective joints; the kinetic information is information about a force influencing the motion of the body and includes ground reaction and moment information; and the energy consumption information is data estimated based on both a heart rate, which is measured using a heart rate monitor, and a muscle activity amount, which is a biometric signal extracted by a myoelectric sensor, and includes global energy consumption and local energy consumption information about each body part.

18. The method of claim 11, wherein receiving the search target dance is configured such that the dance attribute search is performed based on a query from the user, related to at least one of a tempo, power, flexibility, complexity, space utilization, difficulty, and focused body part of each dance motion.

19. The method of claim 11, wherein displaying the choreographic data is configured to provide a function for omnidirectionally viewing the choreographic data to the user.

20. The method of claim 11, wherein displaying the choreographic data is configured to display the biomechanical information in the choreographic data in different colors for respective levels.
